(19) United States
(12) Patent Application Publication
(10) Pub. No.: US 2020/0159922 A1
(43) Pub. Date: May 21, 2020

(54) Method, Device, and System for using Variants of Semantically Equivalent Computer Source Code to Protect Against Cyberattacks

(71) Applicant: Office of Intellectual Property, Code 36000, San Diego, CA (US)

(72) Inventor: Stuart H. Rubin, San Diego, CA (US)

(73) Assignee: United States of America as represented by Secretary of the Navy, San Diego, CA (US)

(21) Appl. No.: 16/197,019

(22) Filed: Nov. 20, 2018

(51) Int. Cl. G06F 21/56

(52) U.S. Cl. CPC G06F 21/563; G06F 2221/033

(57) ABSTRACT

A cyber-security validator stores first computer source code and second computer source code received via an interface in a memory. The cyber-security validator compares the first computer source code and the second computer source code during at least one stage from storage through compilation and execution. The cyber-security validator determines whether a cyberattack has occurred or is in progress based on results of the comparison.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil, referencing NC 103705.

### FIELD OF THE INVENTION

The present disclosure pertains generally to cyber-security. More particularly, the present disclosure pertains to protecting against cyberattacks using variants of semantically equivalent computer source codes.

### BACKGROUND OF THE INVENTION

The number of computational devices using embedded software is rapidly increasing. Also, the functional capabilities of embedded software are becoming increasingly complex each year.

With the increase in complexity of software systems comes a problem of cyber-security. For complex interactions across software components and subsystems, a great number of lines of source code is needed. Such source code is not only prone to errors but is increasingly becoming the target of cyberattacks. It is not generally possible to produce fault-free source code, and attackers have shown the ability to find and exploit residual faults and use them to formulate cyberattacks.

It is not unusual to find different software systems using substantially similar software. As a result, successful cyberattacks can impact a large number of different installations running similar software.

Conventionally, cyberattacks are detected by detecting viral signatures which indicate that a cyber-attack has occurred. However, this approach is not sufficiently effective, especially as software becomes highly distributed across many processors.

More recent approaches attempt to detect a cyberattack before any recoverable damage occurs. One such approach involves the use of syntactic diversification. This approach uses distinct compilers to create distinct object codes from the same source code. While this approach is somewhat effective, it will only succeed against at most one version of object code. However, as cyberattacks grow in their sophistication, they can succeed against multiple versions of object code simultaneously.

In view of the above, it would be desirable to address shortcomings of conventional approaches for providing protection of computer systems against cyberattacks.

### SUMMARY OF THE INVENTION

According to illustrative embodiments, a computing device includes a cyber-security validator. The cyber-security validator is configured to store first computer source code and second computer source code received via an interface in a memory. The cyber-security validator is further configured to compare the first computer source code and the second computer source code during at least one stage from storage through compilation and execution. The cyber-security validator is further configured to determine whether a cyberattack has occurred or is in progress based on results of comparison of the first computer source code and the second computer source code.

These, as well as other objects, features and benefits will now become clear from a review of the following detailed description, the illustrative embodiments, and the accompanying drawings.

### BRIEF DESCRIPTION OF THE DRAWINGS

Features of illustrative embodiments will be best understood from the accompanying drawings, taken in conjunction with the accompanying description, in which similarly-referenced characters refer to similarly-referenced parts, and in which:

FIG. 1 illustrates an example of a computer-based system using semantically equivalent variants of computer source code to protect against a cyberattack according to an illustrative embodiment.

FIG. 2 illustrates a flow chart showing steps in a computer-based method for using semantically equivalent variants of computer source code to provide for protection against a cyberattack according to an illustrative embodiment.

FIG. 3 illustrates a computing device that may be used in the computer-based system shown in FIG. 1 according to an illustrative embodiment.

### DETAILED DESCRIPTION OF THE EMBODIMENTS

According to illustrative embodiments, variants of semantically equivalent computer source code that are intended to produce the same results when compiled and executed are used to detect a cyberattack. While a cyberattack may succeed against one of the computer source codes, it is highly unlikely that an attack will succeed against multiple variants of the computer source code. Thus, using semantically equivalent variants of computer source code provides for protection against cyberattacks.

As an extra layer of protection against cyberattacks, variants of the semantically equivalent computer source code are compared during stages from storage through compilation and execution to determine whether a cyberattack has occurred or is in progress. By detecting a cyberattack at various intermediate stages, the cyber-attack may be stopped before irrecoverable damage occurs.

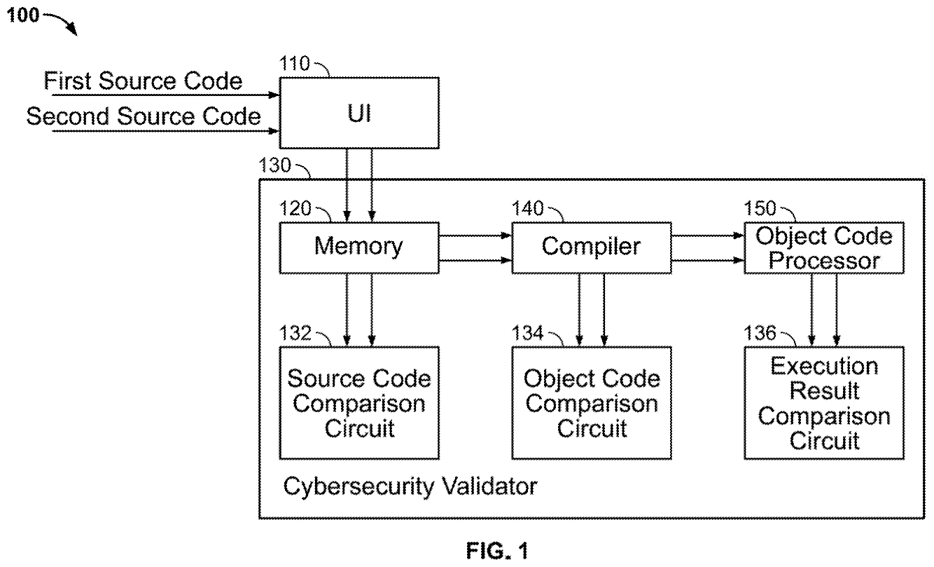

FIG. 1 illustrates an example of a computer-based system 100 for protecting against a cyberattack using semantically equivalent variants of computer source code according to an illustrative embodiment. As shown in FIG. 1, the computer-based system 100 includes a user interface (UI) 110 from which first computer source code and second computer source code are received. The first computer source code is a semantically equivalent variant of the second computer source code. For example, the first computer source code may be received from a first user, and the second computer source code may be received from the same user or a second user. The first computer source code and the second computer source code may be written by one or more human programmers. Alternatively, the first computer source code and the second computer source code may be automatically synthesized by a computing device based on user input using case-based programming or component-based programming.

The computer-based system 100 also includes a cyber-security validator 130 configured to store the first computer source code and the second computer source code in a memory, compare the first computer source code and the second computer source code during at least one stage from storage through compilation and execution, and determine whether a cyberattack has occurred or is in progress based on results of the comparing.

In particular, the cyber-security validator 130 includes a memory 120 configured to store the first computer source code and second computer source code received via the user interface 110. The cyber-security validator 130 also includes a source code comparison circuit 132 configured to compare the first computer source code and the second computer source code stored in the memory 120 to determine whether the first computer source code and the second computer source code are semantically equivalent.

For example, in the case of first computer source code and second computer source code configured to produce a sort of numbers, a cyberattack may be detected by determining whether both the first computer source code and the second computer source code indicate that numbers are to be sorted, before a sort is executed. If both the first computer source code and the second computer source code indicate that numbers are to be sorted, then the first computer source code and the second computer source code are determined to be semantically equivalent, and the assumption is that a cyberattack has not occurred at this stage. If, however, either the first computer source code or the second computer source code indicates that information other than numbers is to be sorted, then the first computer source code and the second computer source code are determined not to be semantically equivalent.

If the source code comparison circuit 132 determines that the first computer source code and the second computer source code are not semantically equivalent, the cyber-security validator 130 determines that the cyberattack has occurred or is in progress. Progression to the compilation stage may stop, such that measures may be taken to avoid irrecoverable damage by the cyberattack.

If it is determined that a cyberattack has not occurred or is not in progress at this stage, processing of the first computer source code and the second computer source code continues to compilation. For this purpose, the cyber-security validator 130 includes at least one compiler 140 configured to compile the first computer source code and the second computer source code stored in the memory 120 to produce first object code and second object code, respectively. The cyber-security validator 130 also includes an object code comparison circuit 134 configured to compare the first object code and the second object code and determine whether there is a difference between the first object code and the second object code. If the object code comparison circuit 134 determines that the first object code and the second object code are different, the cyber-security validator 130 determines that the cyberattack has occurred or is in progress, and measures may be taken to stop the cyberattack.

If the first object code and the second object code are not determined to be different, the cyber-security validator 130 determines that a cyberattack has not occurred or is not in progress at this stage, and processing of the first object code and the second object code continues to execution. For this purpose, the cyber-security validator 130 includes at least one object code processor 150 configured to execute the first object code and the second object code to produce a first result and a second result, respectively. The cyber-security validator 130 also includes an execution result comparison circuit 136 configured to compare the first result and the second result to determine whether the first result and the second result are different.

If the execution result comparison circuit 136 determines that the first result and the second result are different, the cyber-security validator 130 determines that the cyberattack has occurred or is in progress. Otherwise, if the execution result comparison circuit 136 determines that the first result and the second result are the same, the cyber-security validator 130 determines that a cyberattack has not occurred.

It should be appreciated that, although three distinct comparison circuits 132, 134 and 136 are shown in FIG. 1, the comparison circuits may be included in a single comparison circuit. Further, it is not necessary that all of the comparison circuits perform comparisons. For example, since semantically equivalent variants of computer source code are intended to produce the same result when compiled and executed, any difference between the first result and the second result is an indication that a cyberattack has occurred or is occurring. Accordingly, it may be sufficient to only use the execution result comparison circuit 136. However, using the source code comparison circuit 132 and/or the object code comparison circuit 134 ensures that a cyberattack that occurs before execution may be detected, such that steps may be taken to minimize damage caused by the cyberattack.

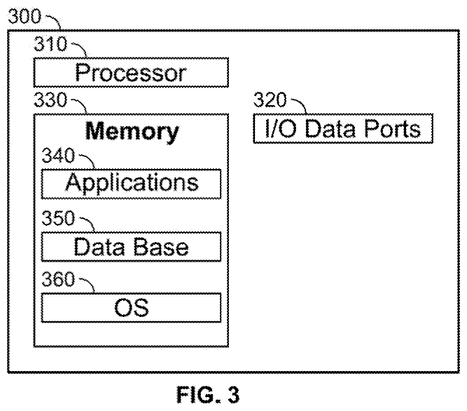

Components of the cyber-security validator 130 may be included in one or more computing devices, such as the computing device 300 shown in FIG. 3 and described in more detail below.

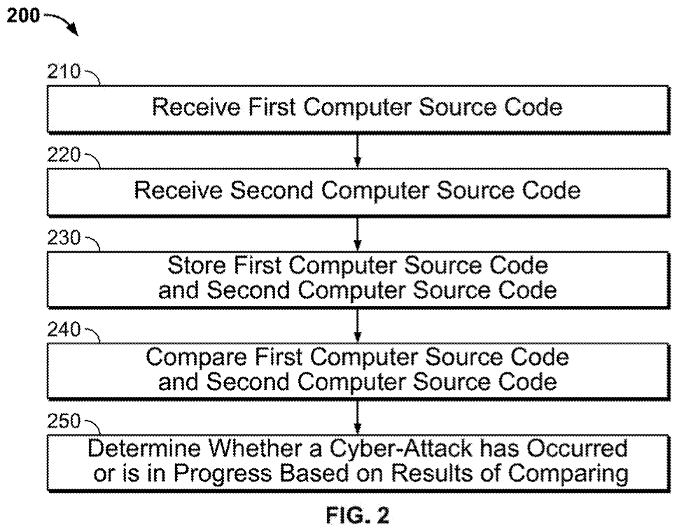

FIG. 2 illustrates a flow chart showing steps in a method for using semantically equivalent variants of computer source codes to provide for protection against cyberattacks according to an illustrative embodiment. It should be appreciated that the steps and order of steps described and illustrated are provided as examples. Fewer, additional, or alternative steps may also be involved and/or some steps may occur in a different order.

Referring to FIG. 2, the method 200 begins at step 210 at which first computer source code is received via an interface, such as the user interface 110 shown in FIG. 1. At step 220, second computer source code is received via, e.g., the user interface 110. While shown as distinct steps, it should be appreciated that steps 210 and 220 may be performed at the same time or in the opposite order.

At step 230, the first computer source code and the second computer source code are stored in memory, e.g., the memory 120 shown in FIG. 1.

At step 240, the first computer source code and the second computer source code are compared during at least one stage from storage through compilation and execution. This comparison may be performed by the cyber-security validator 130 shown in FIG. 1.

For example, comparison of the first computer source code and the second computer source code stored in the memory 120 may be performed by the source code comparison circuit 132. Comparison of first object code and second object code resulting from compiling the first computer source code and the second computer source code may be performed by the object code comparison circuit 134. Comparison of a first result and a second result of executing the first object code and the second object code, respectively, may be performed by the execution result comparison circuit 136 included in the cyber-security validator 130.

At step 250, a determination is made whether a cyberattack has occurred or is in progress based on results of comparing. 230. This determination may be made by the cyber-security validator 130.

Although not shown in the flowchart in FIG. 2, it should be appreciated that once the cyber-security validator 130 determines that a cyberattack has occurred or is in progress, progression of the first computer source code and the second computer source code from storage through the compilation and execution stages sops, such that measures may be taken to address the cyberattack. That is, if the cyber-security validator 130 determines that a cyberattack has occurred or is in progress at the stage during which the first computer source code and the second computer source code are stored in the memory, the first computer source code and the second computer are not compiled and executed. If the cyber-security validator 130 determines that a cyber-attack has occurred or is in progress at the compilation stage, the first object code and the second object code are not executed.

FIG. 3 is a block diagram of a computing device 300 with which various components of the cyber-security validator 130 may be implemented. Although no connections are shown between the components illustrated in FIG. 3, those skilled in the art will appreciate that the components can interact with each other via any suitable connections to carry out device functions.

The term “application”, or variants thereof, is used expansively herein to include routines, program modules, program, components, data structures, algorithms, and the like. Applications can be implemented on various system configurations, including single-processor or multiprocessor systems, minicomputers, mainframe computers, personal computers, handheld-computing devices, microprocessor-based, programmable consumer electronics, combinations thereof, and the like. The terminology “computer-readable media” and variants thereof, as used in the specification and claims, includes non-transitory storage media. Storage media can include volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that can be used to store information that can be accessed.

Referring to FIG. 3, the computing device 300 includes a processor 310 that receives inputs and transmits outputs via input/output (I/O) Data Ports 320. The I/O Data Ports 320 can be implemented with, e.g., any suitable interface through which data may be received and transmitted wired and/or wirelessly. For example, in the case of the computing device 300 used in the cyber-security validator 130 shown in FIG. 1, the inputs may include first computer source code and second computer source code received via the user interface 110.

Although not shown, the computing device 300 may also include a physical hard drive. The processor 310 communicates with the memory 330 and the hard drive via, e.g., an address/data bus (not shown). The processor 310 can be any commercially available or custom microprocessor. The memory 330 is representative of the overall hierarchy of memory devices containing the software and data used to implement the functionality of the computing device 300. The memory 330 can include, but is not limited to, the types of memory devices described above. As shown in FIG. 3, the memory 330 may include several categories of software and data used in the computing device 300, including applications 340, a database 350, an operating system (OS) 360, etc.

The applications 340 can be stored in the memory 330 and/or in a firmware (not shown) as executable instructions and can be executed by the processor 310. The applications 340 include various programs that implement the various features of the computing device 300. For example, in the case of the cyber-security validator 130 shown in FIG. 1, the applications 340 may include applications to implement the functions of the cyber-security validator 130, including the source code comparison circuit 132, the object code comparison circuit 134, the execution result comparison circuit 136 and/or the compiler 140 and the object-code processor 150.

The database 350 represents the static and dynamic data used by the applications 340, the operating system (OS) 360, and other software programs that may reside in the memory. The database 350 may be used to store various data including data needed to execute the applications 340. For example, in the case of the cyber-security validator 130 shown in FIG. 1, the database 350 may store, e.g., the first computer source code and the second computer source code received via the user interface 110.

While the memory 330 is illustrated as residing proximate the processor 310, it should be understood that at least a portion of the memory 330 can be a remotely accessed storage system, for example, a server on a communication network, a remote hard disk drive, a removable storage medium, combinations thereof, and the like.

It should be understood that FIG. 3 and the description above are intended to provide a brief, general description of a suitable environment in which the various aspects of some embodiments of the present disclosure can be implemented. While the description includes a general context of computer-executable instructions, the present disclosure can also be implemented in combination with other program modules and/or as a combination of hardware and software in addition to, or instead of, computer readable instructions.

Further, although FIG. 3 shows an example of how a computing device 300 with components of the cyber-security validator 130 may be implemented, those skilled in the art will appreciate that there may be other computer system configurations, including, for example, multiprocessors, parallel processors, virtual processors, distributed computing systems, microprocessors, mainframe computers, and the like.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A computing device, comprising:
a cyber-security validator configured to:
store first computer source code and second computer source code received via an interface in a memory;
compare the first computer source code and the second computer source code during at least one stage from storage through compilation and execution; and
determine whether a cyberattack has occurred or is in progress based on results of comparison of the first computer source code and the second computer source code.

2. The computing device of claim 1, wherein the cyber-security validator includes a source code comparison circuit configured to compare the first computer source code and the second computer source code stored in the memory to determine whether the first computer source code and the second computer source code are semantically equivalent, wherein if the first computer source code and the second computer source code are determined not be semantically equivalent, the cyber-security validator determines that the cyberattack has occurred or is in progress.

3. The computing device of claim 1, wherein the cyber-security validator includes at least one compiler configured to compile the first computer source code and the second computer source code stored in the memory to produce first object code and second object code, respectively.

4. The computing device of claim 3, wherein the cyber-security validator includes an object code comparison circuit configured to compare the first object code and the second object code and determine whether there is a difference between the first object code and the second object code, wherein if the first object code and the second object code are determined to be different, the cyber-security validator determines that the cyberattack has occurred or is in progress.

5. The computing device of claim 3, wherein the cyber-security validator includes at least one object code processor configured to execute the first object code and the second object code to produce a first result and a second result, respectively.

6. The computing device of claim 5, wherein the cyber-security validator includes an execution result comparison circuit configured to compare the first result and the second result to determine whether the first result and the second result are different.

7. The computing device of claim 6, wherein if the first result and the second result are different, the cyber-security validator determines that the cyberattack has occurred or is in progress.

8. The computing device of claim 6, wherein if the first result and the second result are the same, the cyber-security validator determines that the cyberattack has not occurred or is not in progress.

9. A computer-based method, comprising:
receiving first computer source code via a user interface;
receiving second computer source code via the user interface, wherein the second computer source code is a semantically equivalent variant of the first computer source code;
storing the first computer source code and the second computer source code in a memory;
comparing the first computer source code and the second computer source code during at least one stage from storage in the memory through compilation and execution; and
determining whether a cyberattack has occurred or is in progress based on results of the comparing.

10. The computer-based method of claim 9, wherein:
the step of comparing includes comparing the first computer source code and the second computer source code stored in the memory; and
the step of determining includes determining if the first computer code stored in the memory is semantically equivalent to the second computer source code stored in the memory.

11. The computer-based method of claim 10, wherein the step of determining further includes determining that the cyberattack has occurred or is in progress if the first computer source code stored in the memory is determined not to be semantically equivalent to the second computer source code stored in the memory.

12. The computer-based method of claim 9, further comprising compiling the first computer source code and the second computer source code stored in the memory to produce first object code and second object code, respectively.

13. The computer-based method of claim 12, wherein:
the step of comparing includes comparing the first object code and the second object code; and
the step of determining includes determining whether the first object code and the second object code are different.

14. The computer-based method of claim 13, wherein the step of determining further includes determining that the cyberattack has occurred or is in progress if the first object code and the second object code are determined to be different.

15. The computer-based method of claim 12, further comprising executing the first object code and the second object code to produce a first result and a second result, respectively.

16. The computer-based method of claim 15, wherein:
the step of comparing includes comparing the first result and the second result; and
the step of determining includes determining whether the first result and the second result are different.

17. The computer-based method of claim 16, wherein the step of determining further includes determining that a cyberattack has occurred or is in progress if the first result and the second result are determined to be different.

18. A computer-based system, comprising:
a user interface configured to receive first computer source code from a first user and second computer source code from a second user, wherein the second computer source code is a semantically equivalent variant of the first computer source code;
a cyber-security validator including:
a memory configured to store the first computer source code and the second computer source code received via the user interface;
at least one compiler configured to execute the first computer source code and the second computer source code stored in the memory to produce first object code and second object code, respectively; and
at least one object code processor configured to execute the first object code and the second object code to produce a first result and a second result, respectively,
wherein the cyber-security validator is configured to determine whether a cyberattack has occurred or is in progress by performing at least one of:
comparing the first computer source code and the second computer source code stored in the memory;
comparing the first object code and the second object code; and
comparing the first result and the second result.

19. The computer-based system of claim 18, wherein the cyber-security validator is further configured to determine whether:
the first computer source code stored in the memory is semantically equivalent to the second computer source code stored in the memory;
the first object code is different from the second code object code; or
the first result is different from the second result.

20. The computer-based system of claim 19, wherein the cyber-security validator is further configured to determine that the cyberattack has occurred or is in progress if:
the first computer source code is determined not to be semantically equivalent to the second computer source code;
the first object code is determined to be different from the second object code; or
the first result is determined to be different from the second result.
